(19) United States
(12) Patent Application Publication
(10) Pub. No.: US 2008/0038456 A1
(43) Pub. Date: Feb. 14, 2008

(54) Method of covering clear aperture of optic during deposition of glue protection layer

(75) Inventor: Matthew Lipson, Stamford, CT (US)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Holding N.V., DR Veldhove (NL)

(21) Appl. No.: 11/826,197

(22) Filed: Jul. 12, 2007

Related U.S. Application Data
(63) Continuation of application No. 10/756,352, filed on Jan. 14, 2004, now abandoned.

(51) Int. Cl. B05D 5/06

(52) U.S. Cl. 427/162

(57) ABSTRACT

A system and method that can be used to cover a portion (e.g., a clear aperture) of an optical element (e.g., a lens) during coating of another portion (e.g., a circumferential portion) of the optical element. This can be done to protect the clear aperture during coating of an adhesive protection layer proximate a circumferential edge of the lens without damaging or altering the clear aperture. The method can include the following steps. An optical element is held so that a first portion of the optical element is covered and a second portion of the optical element is exposed. A first coating is provided on the second portion of the optical element. The optical element is released from being held. A second coating is provided on the optical element. The first and second coatings are removed from the second portion of the optical element.

This application is a continuation of U.S. patent application Ser. No. 10/756,352, entitled “Method Of Covering Clear Aperture Of Optic During Deposition Of Glue Protection Layer,” and filed on Jan. 14, 2004, the entirety of which is incorporated by reference herein.

### BACKGROUND OF THE INVENTION

1. Field of the Invention

The present invention is related to a method and system for forming a clear aperture on an optical element held in an optical system.

2. Background Art

Many optical systems include optical elements (e.g., lenses) that are held in specific locations and orientations in a light path. Care must be taken to minimize any force on the lens causing twisting or bending of the lens, and distortion of the optical characteristics of the lens. This is because distortion can cause a light beam passing through the lens to be misdirected. Typically, the lens is supported through the use of gluing or adhering a support device to its circumferential edge, which can substantially reduce or eliminate any distortion. However, stray or scattered light inside the lens can deteriorate the glue, which in some cases causes the lens to separate from the support device, hereby allowing the lens to shift position and misdirect the light.

For example, in lithography systems lenses can be held in this arrangement. Lithography is a process used to create features on the surface of a substrate. Such substrates can include those used in the manufacture of flat panel displays (e.g., liquid crystal displays), circuit boards, various integrated circuits, and the like. Frequently used substrates for such applications are a semiconductor wafer or a glass substrate. While this description is written in terms of a semiconductor wafer for illustrative purposes, one skilled in the art would recognize that this description also applies to other types of substrates known to those skilled in the art.

During lithography, a wafer, which is disposed on a wafer stage, is exposed to an image (e.g., a pattern) formed by an illumination system outputting an illumination beam that interacts with a pattern generating device (e.g., a reticle, mask, a spatial light modulator (e.g., a digital mirror device, a grating light valve, a liquid crystal display device, or the like), a contrasting device, etc.), or array thereof. The image is projected onto the surface of the wafer by exposure optics located within a lithography apparatus. Either or both of the illumination system and the exposure optics may include one or more lenses supported as described above.

In optical systems, such as lithography systems, that use smaller and smaller wavelengths of light (e.g., extreme ultra violet, etc.), even a small distortion or misalignment of the lens can cause errors in the features, which can make a patterned feature inoperable. Thus, a lens needs to be held in a stationary position throughout the process.

In order to protect the glue or adhesive holding the support device to the lens, typically a protection layer is applied to a circumferential portion of the lens. The protection layer is used to absorb light and/or protect the glue or adhering material from damage due to interaction with scattered or stray light inside the lens. A central portion or “clear aperture” of the lens must be protected or “masked”.

Therefore, what is needed is a mask for the clear aperture that can: define a sharp border for the clear aperture with specified tolerance, be spatially positioned to a specified tolerance, be free of pinholes or other defects which would allow the glue protection to obscure the clear aperture, be easily removable so as to leave no damage or distortion or contamination on the surface of the clear aperture, and be applied in such a way as to minimize handling of the optic and thereby minimize opportunity to damage the lens. Further, the mask can be applicable to a range of optics and clear apertures of widely varying shapes and sizes with minimal re-tooling. Further, the mask can be amenable to aqueous/mechanical cleaning and can have outgas levels low enough so as not to interfere with subsequent vapor deposition steps.

### BRIEF SUMMARY OF THE INVENTION

Aspects of the present invention provide a system and method that can be used to cover a portion (e.g., a clear aperture) of an optical element (e.g., a lens) during coating of another portion (e.g., a circumferential portion) of the optical element. This can be done to protect the clear aperture during coating of an adhesive protection layer proximate a circumferential edge of the lens without damaging or altering the clear aperture through the removal of the covering.

In an embodiment of the present invention a method is provided that includes at least the following steps. An optical element is held so that a first portion of the optical element is covered and a second portion of the optical element is exposed. A first coating is provided on the second portion of the optical element. The optical element is released from being held. A second coating is provided on the optical element. The first and second coatings are removed from the second portion of the optical element, such that the clear aperture is not damaged or optically altered.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an optical element being held using a first type of support device in an optical system having horizontally traveling light beams, according to an embodiment of the present invention.

FIG. 2 shows an optical element being held using a second type of support device in an optical system having vertically traveling light beams, according to an embodiment of the present invention.

FIG. 3 shows a cross-sectional view of an edge portion of the optical element after a method is performed on the optical element, according to an embodiment of the present invention.

FIG. 4 shows an optical element after one step of a method performed on the optical element, according to an embodiment of the present invention.

FIG. 5 shows a flowchart depicting a method being performed on an optical element, according to an embodiment of the present invention.

The present invention will now be described with reference to the accompanying drawings. In the drawings, like reference numbers may indicate identical or functionally similar elements. Additionally, the left-most digit(s) of a reference number may identify the drawing in which the reference number first appears.

### DETAILED DESCRIPTION OF THE INVENTION

Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

An embodiment of the present invention provides a method including at least the following steps. A first mask is clamped to an optic, such that a clear aperture of the optic is exposed, but a surface of the optic to which a glue protection will be applied is covered. A second mask, (e.g., lacquer) can be applied to the clear aperture (the aperture now defined by the clamped on first mask). The lacquer is allowed to cure, the first mask is removed, the optic is cleaned by aqueous/mechanical processes, and the glue protection layer is applied to an entire face of the optic (e.g., using vapor deposition)n. The glue protection layer can be insoluble in both aqueous and organic solvents. Lastly, the lacquer is removed with an organic solvent, such as, but not limited to, acetone.

Lens Holding Systems

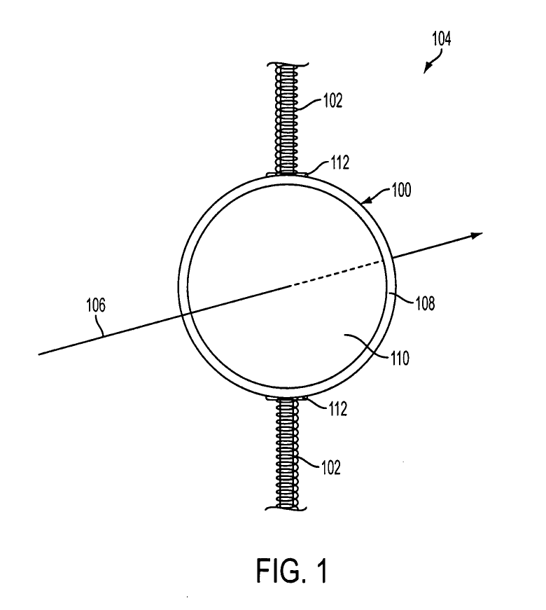

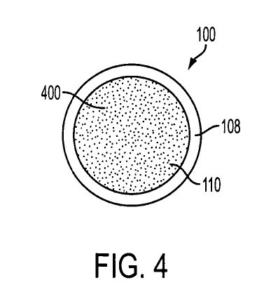

FIG. 1 shows an optical element 100 being held using a first type of support device 102 in an optical system 104 having a horizontally traveling (in the perspective shown) light beam 106, according to an embodiment of the present invention. Optical element 100 includes first portion 108 (e.g., a portion proximate a circumference of optical element 100) and a second portion 110 (e.g., a central portion or a clear aperture). First and second portions 108 and 100 are described in more detail below with respect to FIG. 4.

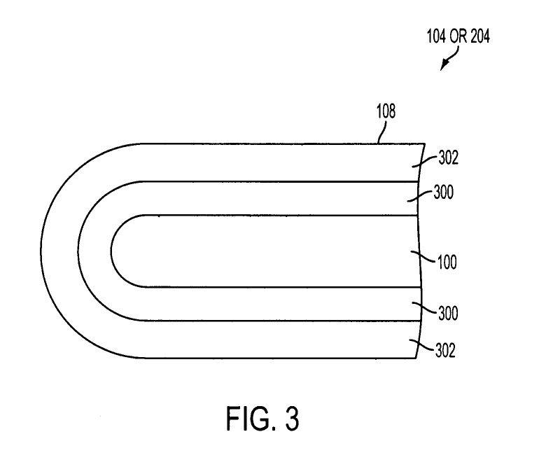

Support device 102 can be a resilient device (e.g., a spring, a stiff spring, or the like). A portion 112 of support device 102 is coupled (using coupling coating 302, as described below with respect to FIG. 3) to first portion 108 of optical element 100. The coupling can be accomplished through the use of non-mechanical, adhering or adhesive coatings or materials, such as glue, or the like. In this arrangement, optical element 100 can be substantially stationary through the use of support device 102 and distortion free through the use of non-mechanically coupling support device 102 to first portion 108 of optical element 100.

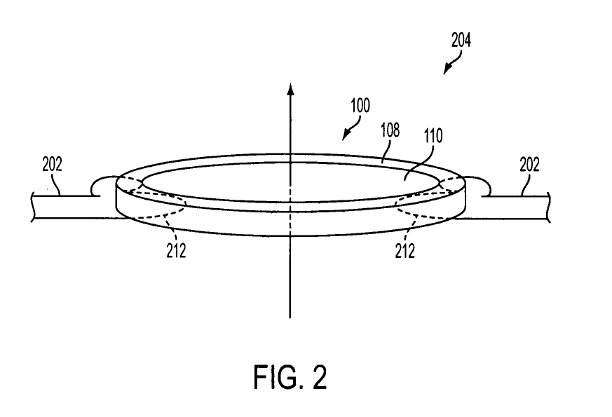

FIG. 2 shows optical element 100 being held using a second type of support device 202 in an optical system 204 having a vertically traveling (in the perspective shown) light beam 206, according to an embodiment of the present invention. In this embodiment, a portion 212 (e.g., fingers, or the like) of support device 202 is coupled to first portion 108 of optical element 100. The coupling can be done similarly to the coupling of support device 102, as described above.

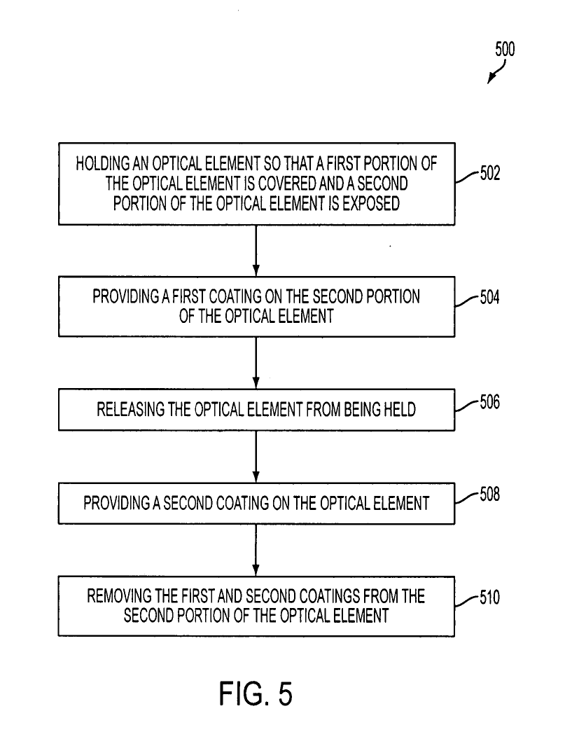

FIG. 3 shows a cross-sectional view of an edge of at least part of first portion 108 of optical element 100 after a method (e.g., method 500 in FIG. 5) is performed on optical element 100, according to an embodiment of the present invention. First portion 108 includes a coating 300 (e.g., tantalum oxide, or the like) and a coupling coating 302. Coupling coating 302 allows for the non-mechanical, adhering or adhesion of support device 102 or 202 to first portion 108, as described above, and can be any material that allows support device 102 or 202 to be non-mechanically secured to first portion 108.

Coating 300 can be used to substantially reduce or eliminate stray or scattered light inside optical element 100 from interacting with coupling coating 302 and deteriorating it. Thus, coating 300 can be seen as a protective layer to protect coupling coating 302. Coating 300 can be an absorbing coating chosen based on a wavelength of light being used in optical system 104 or 204. Various coatings for this purpose will be apparent to one of ordinary skill in the art upon reading this description. All such coatings now known or discovered in the future are contemplated within the scope of the present invention. Coating 300 can be applied using various techniques, for example, vapor deposition or chemical vapor deposition.

Optical Element with Central Portion Covered

FIG. 4 shows optical element 100 after one step of a method (e.g., method 500 shown in FIG. 5) has been performed on optical element 100, according to an embodiment of the present invention. A coating 400 is shown that is substantially only covering second portion 110, usually on both sides of optical element 100.

Coating 400 can be, but is not limited to, an organic compound, an inorganic compound, an organic composition, and inorganic composition, a polymeric composition, a lacquer, a mixture, an aqueous coating, an aqueous polymeric coating, an acrylic polymer, a polymer film, a polymethyl methacrylate, a paint, an enamel, polymer, or acrylic polymer diluted in a solvent, etc., and mixtures or combinations thereof.

In an embodiment when a solvent is used, the solvent can be an aqueous or non-aqueous solvent, such as acetone, ethyl acetate, ether, chloroform, benzene, toluene, ethanol, methanol, cyclohexane, hydrocarbon-based solvent, ketone-based solvent, ether-based solvent, acetate-based solvent, amide-based solvent, .gamma.-butyrolactone, alcohol-based solvent, silicon-based solvent, anisole, mesitylene, xylene, methyl isobutyl ketone, 1-methyl-2-pyrrolidinone, tetrahydrofuran, isopropyl ether, ethyl acetate, butyl acetate, propylene glycol methyl ether acetate, dimethylacetamide, dimethylformamide, .gamma.-butyolactone, isopropyl alcohol, butyl alcohol, octyl alcohol, silicon solvents, etc., and mixtures or combinations thereof.

These lists of coatings and solvents are not meant to be exhaustive. It is to be appreciated other coatings and/or solvents apparent to one of ordinary skill in the art upon reading this description are also contemplated within the scope of the present invention.

In one embodiment, coating 400 is relatively easy to cast, dries hard and clean (e.g., does not evaporate), is not water soluble, and is relatively easy to completely remove using a non-damaging removing material (e.g., acetone).

Coating 400 can be formed on optical element 100 using various techniques, such as, but not limited to, applying, depositing, spraying, air brushing, and painting. It is to be appreciated that other techniques can also be used, as would be apparent to one of ordinary skill in the art upon reading this description.

Method for Covering Central Portion of Optical Element

FIG. 5 shows a flowchart depicting a method 500 being performed on optical element 100 according to an embodiment of the present invention.

In step 502, optical element 100 is held so that first portion 108 of optical element 100 is covered and second portion 110 of optical element 100 is exposed. Optical element 100 can be held with a masking device, or the like, which only covers first portion 108. This preliminary mask can be made of material that is machinable to high precision, is inert to water and typical organic solvents (e.g., acetone, isopropanol, or the like), and is softer than the material from which the optic is made, such that it will not scratch the optic. For example, Delrin can be a preferred material used for this mask. It is to be appreciated that other materials that meet these general guidelines can also be used, and are contemplated within the scope of the present invention.

In step 504, first coating 400 is provided on second portion 110 of optical element 110. Again, as described above, this lacquer can be design to adhere well to the optic, be robust enough to withstand aqueous/mechanical cleaning, be free of pinholes and other defects, be low in outgas once cured so as not to interfere with subsequent vapor deposition of the glue protection layer, and be readily removed by an organic solvent leaving no residue. For example, in a preferred embodiment Maybelline® Cherry Pop! Nail Enamel diluted in ethyl acetate in ratios from 1:2 to 2:1 is applied with an airbrush. It is to be appreciated that numerous other materials and/or compositions can also be used for this lacquer, as are described above, which are apparent to one of ordinary skill in the art upon reading this description as are the methods of application.

In step 506, optical element 100 is released from being held. In step 508, second coating 300 is provided on optical element 100. In step 510, first and second coatings 400 and 300 are removed from second portion 110 of optical element 100. Removal can be accomplished using a removing material, such as acetone or the like, which can substantially completely remove coating 400 without damaging optical element 100.

It is to be appreciated that other, possibly optional, steps can also occur during method 500. For example, processing of optical element 100 can occur, which can include cleaning (e.g., with water having a cleaning material therein), rinsing (e.g., with deionized water), and/or drying of optical element 100. Processing of optical element 100 can occur before step 502, before step 508, and/or after step 510.

In one embodiment, coating 400 can include a coloring material, a dye, or the like. This can help ensure that a visual inspection can be performed to determine whether a thickness of coating 400 is thick enough so that no pin holes are formed in coating 400. Substantial reduction or elimination of pin holes can be desired so that coating 400 is a continuous layer. For example, when coating 400 is a continuous layer, substantially none of coating 302 interacts with lens 100 during step 508.

Once method 500 is completed, support device 102 or 202 can be coupled to first portion 108 of optical element 100 via coupling coating 302.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. (canceled)

2. A method, comprising:
(a) holding an optical element so that a first portion of the optical element is covered and a second portion of the optical element is exposed;
(b) providing a first coating on the second portion of the optical element;
(c) releasing the optical element from being held;
(d) providing a second coating on the optical element, wherein the second coating blocks all light; and
(e) removing the first and second coatings from the second portion of the optical element.

3. The method of claim 2, wherein step (b) further comprises using an organic coating as the first coating.

4. The method of claim 2, wherein step (b) further comprises using a lacquer coating as the first coating.

5. The method of claim 2, wherein step (b) further comprises using an aqueous coating as the first coating.

6. The method of claim 2, wherein step (b) further comprises using an aqueous polymeric coating as the first coating.

7. The method of claim 2, wherein step (b) further comprises using an acrylic polymer coating as the first coating.

8. The method of claim 2, wherein step (b) further comprises using a polymethyl methacrylate coating as the first coating.

9. The method of claim 2, wherein step (d) further comprises using a tantalum oxide coating as the second coating.

10. The method of claim 2, wherein step (e) further comprises using a solvent to remove the first and second coatings.

11. The method of claim 2, wherein step (e) further comprises using an organic solvent to remove the first and second coatings.

12. The method of claim 2, wherein step (e) further comprises using acetone to remove the first and second coatings.

13. The method of claim 2, wherein step (b) further comprises forming a thickness of the first coating so that a substantially pinhole free film is formed as the first coating.

14. The method of claim 2, wherein step (b) further comprises performing one of applying, depositing, spraying, air brushing, and painting the first coating onto the optical element.

15. The method of claim 1, further comprising:
(f) providing a third coating substantially over the second coating on the peripheral portion of the face surface of incidence of the optical element, the third coating being configured to secure a support device to the optical element.

16. The method of claim 15, wherein step (f) further comprises using the second coating to protect the third coating from light exiting the optical element.

17. The method of claim 2, wherein step (b) further comprises using a hardening, non-water soluble, removable coating as the first coating.

18. The method of claim 17, wherein the hardening occurs at room temperature.

19. The method of claim 2, wherein step (d) further comprises performing vapor deposition to provide the second coating.

20. The method of claim 2, wherein the first coating is used to ensure the central portion of the face surface of incidence of the optical element does not receive any of the second coating.

21. A method, comprising:
(a) masking an optical element made from calcium fluoride so that a peripheral portion of a face surface of incidence of the optical element is covered and a central portion of the face surface of incidence of the optical element is exposed;
(b) providing a first coating on the central portion of the face surface of incidence of the optical element;
(c) unmasking the optical element;
(d) providing a second coating over the central and peripheral portions of the face surface of incidence of the optical element, wherein the second coating blocks all light; and
(e) removing the first and second coatings from the central portion of the face surface of incidence of the optical element to form a clear aperture.
